(19) United States
(12) Patent Application Publication
(10) Pub. No.: US 2018/0285870 A1
(43) Pub. Date: Oct. 4, 2018

(54) System and Method for Providing Controlled Temporary Authorization for an Account

(71) Applicant: AFG Rentals LLC, Grandview, TX (US)

(72) Inventors: Leland Ulrich, Grandview, TX (US); Travis L. Riffle, Carrollton, TX (US); Matthew S. O'Brien, Dallas, TX (US)

(21) Appl. No.: 15/940,015

(22) Filed: Mar. 29, 2018

Related U.S. Application Data
(60) Provisional application No. 62/479,054, filed on Mar. 30, 2017.

(51) Int. Cl. G06Q 20/40; H04L 29/06; G06Q 30/06; G06K 19/06

(52) U.S. Cl. CPC G06Q 20/401; G06K 19/06028; G06Q 30/0645; H04L 63/102

(57) ABSTRACT

A system includes a user device and an activation server communicatively coupled to the user device. The user device communicates a registration request to the activation server. The activation server is configured to receive the registration request and determine user information based on information in the registration request. The user information includes one or more of a credit rating of the user, an installation location, one or more user references, and a user preference. The activation server may further determine one or more rent-to-own arrangement characteristics based on the user information and communicate one or more rent-to-own options to the user device compatible with the determined rent-to-own arrangement characteristics. The activation server calculates a minimum purchase amount and a maximum purchase amount for a selected rent-to-own option. The activation server communicates a temporary authorization to purchase a rent-to-own item according to the selected rent-to-own option to the user device.

### RELATED APPLICATION

This application claims the benefit under 35 U.S.C. § 119(e) of the priority of U.S. Provisional Application No. 62/479,054 entitled “SYSTEM AND METHOD FOR PROVIDING CONTROLLED TEMPORARY AUTHORIZATION FOR AN ACCOUNT” on Mar. 30, 2017, the entire disclosure of which is hereby incorporated by reference.

### TECHNICAL FIELD

The present disclosure relates, in general, to account authorization and, more particularly, to a system and method for providing controlled temporary authorization for an account.

### BACKGROUND

Rent-to-own (RTO) arrangements allow customers to rent a product with the option to purchase the product following a rental period. Establishing a RTO arrangement between parties creates potential fraud and non-payment risks. Furthermore, the process of selecting and acquiring the product subject to the arrangement is cumbersome. For example, conventional systems for acquiring a RTO product and financing a RTO product are not compatible. Traditionally, existing authorization systems do not work well with RTO products since they authorize a purchase after the product has been selected and acquired by a purchaser. These factors, amongst others, result in utilizing processing resources unnecessarily to arrange RTO product acquisition and subsequent financing.

### SUMMARY OF THE DISCLOSURE

According to an embodiment, a system includes a user device of a user and an activation server communicatively coupled through a network to the user device. The user device is configured to communicate a registration request to the activation server. The activation server includes memory, one or more interfaces, and processing circuitry. The memory is configured to store one or more instructions. The one or more interfaces are configured to receive the registration request from the user device. The processing circuitry which, when one or more stored instructions are executed, is configured to determine user information based on information in the registration request. The user information includes one or more of a credit rating of the user, an installation location, one or more user references, and a user preference. The processing circuitry may be further configured to determine one or more rent-to-own arrangement characteristics based on the user information. The one or more interfaces may be further configured to communicate to the user device one or more rent-to-own options based on the one or more determined rent-to-own arrangement characteristics and receive a selected rent-to-own option. The processing circuitry may be further configured to calculate a minimum purchase amount and a maximum purchase amount for the selected rent-to-own option. The one or more interfaces of the activation server may be further configured to communicate to the user device, in response to receiving the selected rent-to-own option, a temporary authorization on an account to purchase a rent-to-own item according to the selected rent-to-own option.

In particular embodiments, the system further includes an authorization server. The authorization server includes memory configured to store one or more instructions, one or more interfaces, and processing circuitry. The one or more interfaces may be configured to receive an authorization request on the account from a merchant system. The processing circuitry of the authorization server, which, when one or more stored instructions are executed, is configured to compare the selected rent-to-own option to the authorization request from the merchant system. The processing circuitry may be further configured to authorize the account to purchase the rent-to-own item when a purchase amount of the received authorization request is between the minimum purchase amount and the maximum purchase amount, inclusive. In some embodiments, the processing circuitry is configured to authorize the account within five milliseconds after receiving the authorization request on the account.

Certain embodiments provide one or more technical advantages. For example, certain embodiments may reduce the amount of computing resources in arranging the acquisition and financing of an RTO product. According to certain embodiments, a system may combine systems for determining the RTO product to be acquired and financing for said RTO product, such that the determination of the RTO product to be acquired is carried out in parallel to the process of financing the purchase of the RTO product. As another example, certain embodiments may combine the two, previously incompatible systems for acquiring the RTO product and financing the RTO product, into a single system that reduces the use of processing resources. A system combining these systems may reduce any overlapping processing steps by enabling these two different systems to communicate through their respective interfaces, thereby reducing processing resources used. As yet another example, certain embodiments may create a new authorization data structure for use in a RTO arrangement, such that the acquisition and financing of the RTO product are tied together. This may result in several advantages, such as reducing the risk of fraud or non-payment by preventing the establishment of a certain RTO. Additionally, certain embodiments may authorize the account within five milliseconds after receiving the authorization request on the account and after confirmation of the purchase, establish the RTO contract. In this manner, the account may be funded only when the transaction is occurring, limiting the chance of fraudulent activity on the account and subsequently, or simultaneously, completing the RTO contract, thereby reducing the use unnecessary processing resources in providing RTO arrangements.

Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates an example system for establishing a rent-to-own arrangement, according to certain embodiments;

FIG. 2 illustrates an example system for registering and generating an authorization for a rent-to-own arrangement, according to certain embodiments;

FIG. 3 illustrates an example system for authorizing a user to complete a rent-to-own arrangement, according to certain embodiments; and

FIGS. 4A and 4B are a flowchart illustrating a method for establishing a rent-to-own arrangement using the system of FIG. 1, according to certain embodiments.

### DETAILED DESCRIPTION

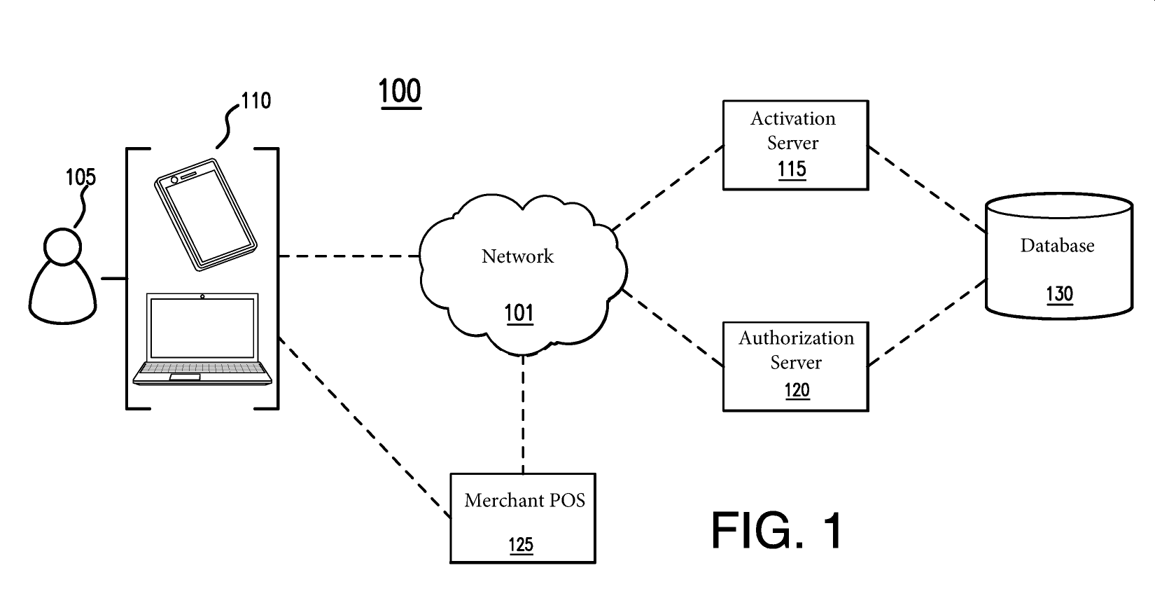

Embodiments of the present disclosure and its advantages are best understood by referring to FIGS. 1 through 4 of the drawings, like numerals being used for like and corresponding parts of the various drawings.

Rent-to-own (RTO) arrangements allow customers to rent an item with the option to own the item product at the end of a lease term. For example, customers may rent furniture or stand-alone sheds by paying periodic rent for a predetermined time and would own the furniture or shed after the lease period ends or may be able to pay a lump sum amount to retain possession and gain ownership of the item. RTO arrangements allow customers to possess items and eventually own them, even if the price of the item cannot be paid up front. For example, the monthly payments may be affordable to the customer and the merchant still receives compensation for the possession of the item by the customer during the rental period and for its sale at the end of the time period.

Conventional ways of establishing RTO arrangements incur several drawbacks. Usually, the process of selecting and acquiring the RTO product and arranging the financing for the RTO product are distinct processes. For example, the selection and purchase of the RTO product may occur prior to arranging the financial obligations incumbent on the customer. In particular, a customer may select a particular product for a RTO arrangement and the financing entity may extend capital to purchase the RTO product, and it may then subsequently transfer possession to the customer based on a RTO contract specifying terms and conditions, including the payment period and payments due. Alternatively, the financing entity may transfer funds to the customer, with which the customer may purchase the RTO product.

Because of the uncertainty that the customer will consummate the RTO contract, be unable to pay according to the accepted terms, or may use transferred funds for unauthorized items, the seller may take on a substantial amount of risk. A customer may make, intentionally or accidently, false representations regarding their ability to pay or their intention to make the periodic payments. Once the customer has the item, it is more difficult to recover in the event of a default. For example, home-improvement installations, such as sheds, may be secured to a property or location. Repossession of the item because of default may result in additional costs and potentially legal barriers. As another example, if the seller provides funds in advance for purchasing an item, the buyer may use the funds in an unauthorized way. For example, the buyer may purchase other items that are not subject to the RTO arrangement.

The conventional RTO arrangement typically accounts for these risks with increased periodic payment amounts and larger upfront deposits by the customer. Unfortunately, the attempt to offset these risks may decrease the attractiveness of RTO arrangements by degrading the advantages such arrangements intend to provide. Traditional methods of establishing such RTO arrangements, such as using cursory background checks and additional contractual provisions to protect the lessor/seller's interest, have failed to address the challenges described above. Systems and methods are needed to provide technical solutions to these problems by improving the establishment of RTO arrangements by connecting the selection of the RTO product with the financing of the RTO arrangement and reducing fraud in establishing RTO arrangements.

FIG. 1 illustrates an example system 100 for establishing a rent-to-own arrangement. System 100 may include network 101, user device 110, activation server 115, authorization server 120, merchant point of sale (POS) 125, and database 130.

According to certain embodiments, network 101 facilitates communication between and amongst the various components of system 100. This disclosure contemplates network 101 being any suitable network operable to facilitate communication between the components of system 100. Network 101 may include any interconnecting system capable of transmitting audio, video, signals, data, messages, or any combination of the preceding. Network 101 may include all or a portion of a public switched telephone network (PSTN), a public or private data network, a local area network (LAN), a metropolitan area network (MAN), a wide area network (WAN), a cellular network, such as a 3G, 4G, 5G, or LTE network, a local, regional, or global communication or computer network, such as the Internet, a wireline or wireless network, an enterprise intranet, or any other suitable communication link, including combinations thereof, operable to facilitate communication between the components.

User devices 110 may be any devices that operate and/or communicate with other components of system 100. User devices 110 may receive information through one or more interfaces of the respective user devices 110. For example, user 105 may input information through an interface of user device 110. In this manner, user device 110 may be provided with information necessary to establish the RTO arrangement. As an example, user 105 may input user information related to the financial status of user 105 and user information related to the desired characteristics of a RTO product. User device 110 may receive the inputted information and process the information to produce a registration request to send to authorization server 120. Additionally, or alternatively, user device 110 may obtain information over one or more interfaces from other components of system 100 and/or external systems. For example, user device 110 may use information from user 105 to access external systems and obtain additional user information to compile the registration request. As another example, user device 110 may access one or more databases to obtain previously entered and/or stored information relevant to user 105 or the desired RTO product. In this manner, user device 110 may access the necessary information to complete a registration request to establish a RTO arrangement.

In certain embodiments, user device 110 may communicate with activation server 115. For example, using obtained information related to user 105 and the desired RTO product, user device 110 may communicate the obtained information to activation server 115. The communication to activation server 115 may enable activation server 115 to determine the necessary user information relevant to the establishment of an RTO arrangement and also determine one or more rent-to-own arrangement characteristics. For example, activation server 115 may use information communicated by user device 110 to determine whether user 105 may qualify to be financed for a particular RTO arrangement and/or what type of RTO product may be compatible with user 105's preferences. User device 110 may also receive information from activation server 115. For example, user device 110 may receive one or more RTO arrangements for which user 105 is eligible. User device 110 may receive two different options that may vary based on the desired financing options or product characteristics. User device 110 may be configured to display those options to user 105. User 105 may then select from the one or more RTO options using one or more interfaces of user device 110. Additionally, in certain embodiments, user device 110 may obtain an authorization on an account from authorization server 120. For example, using the same or a different communication link, user device 110 may receive a temporary authorization from activation server 115 that may enable the purchase of a RTO product. In this manner, user device 110, through communicating with activation server 115, may enable user 105 to establish a RTO arrangement that is compatible with user 105's preferences and qualifications.

This disclosure contemplates device 110 being any appropriate device for sending and receiving communications over network 101. As an example and not by way of limitation, device 110 may be a computer, a laptop, a wireless or cellular telephone, an electronic notebook, a personal digital assistant, a tablet, or any other device capable of receiving, processing, storing, and/or communicating information with other components of system 100. User device 110 may also include a user interface, such as a display, a microphone, keypad, or other appropriate terminal equipment usable by user 105. In some embodiments, an application executed by user device 110 may perform the functions described herein.

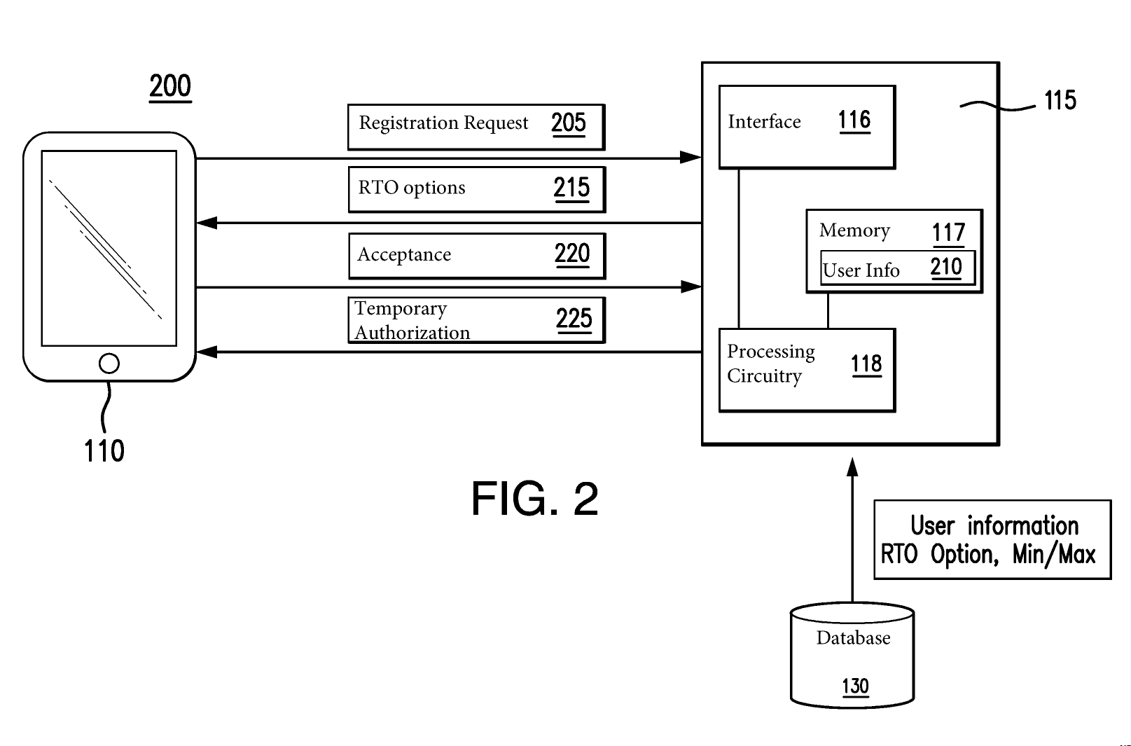

In certain embodiments, user 105 may operate user device 110 to send a registration request through network 101 to activation server 115. The registration request may comprise certain information about user 105 and the desired RTO arrangement. Activation server 115 may use this information to determine and communicate one or more RTO options to user device 110. If user 105 accepts one of the provided options, activation server 115 generates a temporary authorization and associates the temporary authorization with an account. The account may be a checking account, an account associated with an application loaded on user device 110, and/or a credit account with one or more credit card numbers. User 105 may purchase the product associated with the RTO arrangement. In certain embodiments, user 105 may use the account associated with the temporary authorization to purchase the produce associated with the RTO arrangement. The temporary authorization on user device 110 may be presented to a merchant selling the product. Further details regarding the activation of the RTO arrangement, according to certain embodiments are found below in reference to FIG. 2.

Authorization server 120 may be configured to authorize the use of an account based on provided information from user device 110. For example, authorization server 120 may be provided an authorization request from merchant POS 125 via a request from user device 110 at the time of purchase. Authorization server 120 may compare the authorization request to the temporary authorization provided to user 110. For example, authorization server 120 may determine whether the authorization request is compatible with the user information of user 105, the RTO option selected by user 105, the price range of the selected option, and any other parameters associated with the generated temporary authorization state. If the authorization request is not compatible with the relevant information, authorization server 120 may communicate a denial of authorization to merchant POS 125. Alternatively, if the authorization request is deemed valid, authorization server 120 may communicate a confirmation of authorization. In some embodiments, authorization server 120 may communicate with an account manager system that is associated with the account. For example, merchant POS 125 may, based on the provided temporary authorization, communicate with the account manager system, which then requests confirmation from authorization server 120. Authorization server 120 may determine whether to confirm or deny the request and communicate the decision to the account manager system, which then may communicate with merchant POS 125 in furtherance of the transaction. Authorization server 120 may be configured to enable the additional functionality of the account manager system, such as allowing just-in-time funding of the authorized account, without additional processing resources.

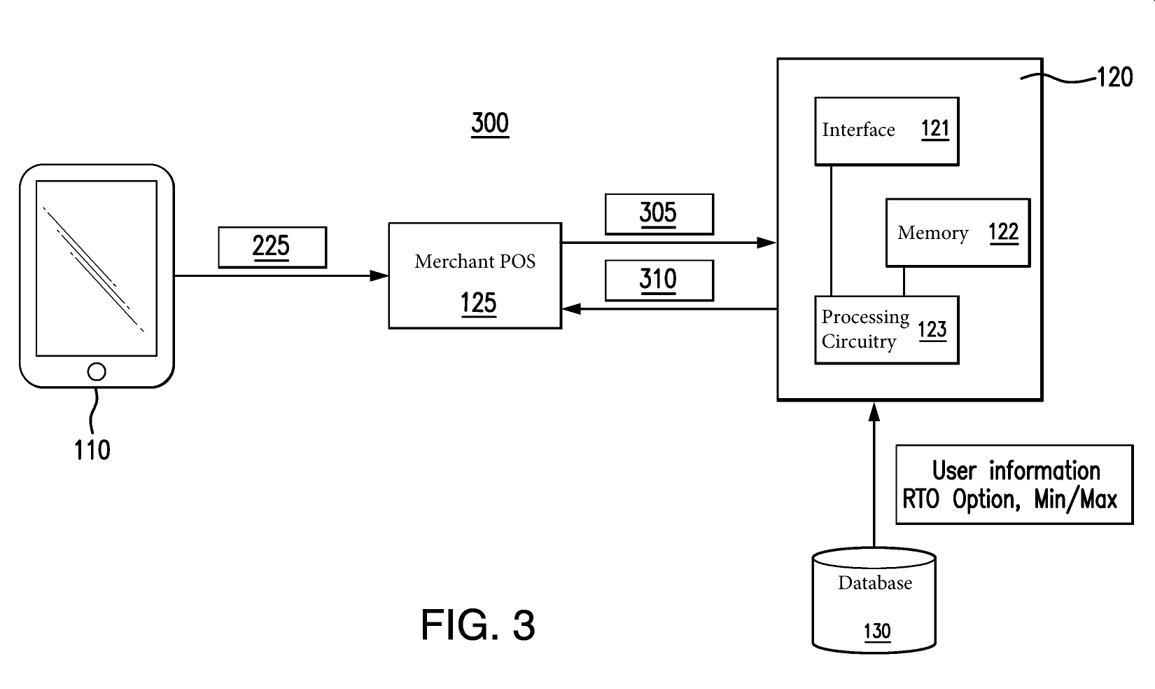

Merchant POS 125 may be configured to communicate with authorization server 120 based on the temporary authorization provided to user device 110. Merchant POS 125 may receive one or more credentials from a buyer, such as user 105, to confirm authorization to withdraw funds from a specified account to complete the purchase of the product. For example, a buyer may specify the manner in which the product may be paid, such as in cash, credit, debit, or check. In some cases, the buyer may present credentials to confirm authorization for the merchant to withdraw funds from a specific account. Merchant POS 125 may receive the presented credentials and communicate those credentials with the authorization request for the purchase to authorization server 120, either directly or through a separate system, such as an account manager system. Authorization server 120 may provide the merchant POS 125 with confirmation of the authorization to withdraw funds from the specified account. Merchant POS 125 may then process the transaction and complete the sale of the product to the buyer. In one example, user device 110 may communicate the temporary authorization to merchant POS 125. Merchant POS 125 may communicate the temporary authorization with the transaction details, including the product information and price, to a third-party system. Merchant POS 125 may then receive authorization or a denial based on the provided information and temporary authorization. While described as a merchant POS, the authorization provided by user device 110 may be communicated to any point-of-sale or payment processing system, including internet processing payment platforms and nontraditional retail or merchant POS systems. For example, merchant POS 125 may be a terminal operated by a cashier at a retail location that receives credentials, e.g., a credit card number, and communicates with the authorizing entity, e.g., the credit card company, to confirm authorization based on the presented credentials. Further details regarding the authorization to purchase the product associated with the RTO arrangement, according to certain embodiments are found below in reference to FIG. 3.

In certain embodiments, one or more of activation server 115 and authorization server 120 may be implemented on a cloud network or a distributed processing system. For example, portions of activation server 115 may be geographically distributed or utilize virtual resources using physical components shared with other servers. In some embodiments, activation server 115 and authorization server 120 may share one or more hardware and/or software components. For example, activation server 115 and authorization server 120 may reside on a common server rack or implemented on the same virtual resources in a cloud network.

Database 130 may store various information used to establish the RTO arrangement. For example, database 130 may be made to store user information of user 105, including information obtained by activation server 115 based on information received by user device 110 in user 105's registration request. In certain embodiments, database 130 may also store information about the status of the RTO arrangement. For example, database 130 may store the temporary authorization communicated to user device 110, including the parameters of the temporary authorization. One or more of activation server 115 and authorization server 120 may access database 130 to access or store data in order to facilitate the establishment of the RTO arrangement. Database 130 may comprise memory, processing circuitry, and one or more interfaces. The information communicated to database 130 may be stored in memory, whereas the processing circuitry of database 130 may allow database 130 to process the information and determine access to information by activation server 115 and/or authorization server 120. One or more interfaces of database 130 may be configured to allow communication between database 130 and one or more of activation server 115 and/or authorization server 120.

In certain embodiments, database 130 may be communicatively coupled to each of activation server 115 and authorization server 120. For example, data or information may be communicated between activation server 115 and database 130 and authorization server 120 and database 130. In certain embodiments, activation server 115 and authorization server 120 may also be communicatively coupled such that activation server 115 and authorization server 120 may exchange information without database 130. In certain embodiments, database 130 is incorporated into one or more of activation server 115 and authorization server 120. In some embodiments, database 130 is distributed over multiple components, such as multiple servers or virtual resources.

In one exemplary embodiment, user 105 provides user device 110 with identifying information, such as user 105's name, address, phone number, and/or ID. User 105 may also provide certain RTO product preferences. In this example, user 105 may desire to enter a RTO arrangement for a shed to be located on his property. User 105 may then provide user device 110 with characteristics of the desired shed, such as square footage, construction, and/or design features. User device 110 may compile this information into a registration request. For example, user device 110 may have pre-loaded a user application that enables the transmission of a registration request to activation server 115. The pre-loaded user application may have various fields in which user 105 may fill in the relevant information. The registration request may be communicated from user device 110 to activation server 115.

At activation server 115, information in the registration request may be stored in memory and processed to determine user information. For example, activation server 115 may process the registration request to determine a credit rating of user 105, an installation location of the shed, a user reference for user 105, and the shed characteristics desired by user 105. Activation server 115 may communicate with external systems to determine certain user information. For example, the credit rating of user 105 may be determined by processing the registration request for identifying information of user 105 and communicating with external systems to enable a credit check of user 105. After acquiring the relevant user information, activation server 115 may use the user information to determine one or more RTO arrangement characteristics. These may include the financing options, such as the term-length, monthly payments, etc. and shed characteristics, such as the product models, size, construction, and other features of the shed. Using these characteristics, activation server 115 may filter the available RTO products to determine one or more RTO options to communicate to user 105. For example, there may be a catalog of various shed products that may be available for a RTO arrangement. Based on user 105's desired characteristics and/or ability to make payments on the shed, certain catalog items may be excluded from consideration or certain payment plans may be excluded from being presented to user 105. In this manner, activation server 115 may narrow down the options to those most compatible with user 105's preferences and financial capabilities.

Activation server 115 may then communicate the RTO shed options to user device 110. User 105 may select one of the RTO shed options through the pre-loaded application on user device 110. User device 110 may then communicate the selected option to activation server 115. Activation server 115 may then calculate one or more parameters based on the selected option. For example, activation server 115 may determine a minimum and a maximum purchase amount for the accepted RTO shed. Activation server 115 may determine, based on suggested retail prices, or actual offered prices at particular merchants, the cost of the RTO shed. Based on this estimated cost, activation server 115 may determine the minimum price and the maximum price that would likely be paid to purchase the RTO shed at the specified retailer(s). In some cases, the minimum price would be calculated as 90% of the estimated cost and the maximum price would be calculated as 110% of the estimated cost. In this manner, activation server 115 may easily determine a minimum and maximum purchase amount based on the accepted RTO option. In other cases, the minimum and maximum purchase amounts are determined asymmetrically or independently based on the range of prices for the specific RTO shed.

Activation server 115 may then communicate a temporary authorization on an account to user device 110. The temporary authorization may include a credential, such as an account number and account user information, that may be presented to a merchant to purchase the RTO product. For example, after accepting a RTO option for a particular shed and payment plan, activation server 115 may communicate an account number and authorization information to a mobile wallet on user device 110. The mobile wallet may be any secure application loaded on user device 110 that may be used to present credentials to a merchant or payment processor through user device 110. In this manner, the temporary authorization may be communicated over network 101 and instantaneously available to user 105 through user device 110.

User 105 may then go to a retailer selling the RTO shed and present user device 110 containing the temporary authorization. The merchant may use merchant POS 125 to communicate the presented temporary authorization to the account management system associated with the account. In this preferred embodiment, the account management system may be a just-in-time account management system, which only transfers funds into the target account when the transaction is authorized. The account management system may communicate the temporary authorization and transaction information to authorization server 120. Authorization server 120 may compare the temporary authorization and the transaction information to the accepted RTO option associated with user 105. For example, authorization server 120 may confirm that the shed being purchased by user 105 is the product indicated in the accepted RTO option. Authorization server 120 may also compare the purchase price of the shed to the minimum and maximum purchase prices associated with the RTO option. If the product and purchase amounts are compatible with the RTO option, e.g., the product matches the accepted RTO shed and the purchase amount is between the minimum and maximum purchase amounts, authorization server 120 may authorize the purchase using the account to purchase the RTO shed. Authorization server 120 may carry out the authorization processes within five milliseconds to ensure that any account management systems do not deny valid authorization requests.

Once the purchase has been made by user 105, authorization server 120 may associate user 105 with a RTO contract for the purchased shed. For example, authorization server 120 may generate RTO contract terms based on the accepted RTO option after confirming the purchase of the shed at a particular price. The terms may include payment amounts, payment terms, and interest amounts in case of late payments or default. Authorization server 120 may also include relevant details into the RTO contract such as the identifying information of user 105 and the installation location of the shed. User 105 may use user device 110 to complete the contractual arrangement and view the terms and conditions of the RTO arrangement prior to and during the RTO term.

Modifications, additions or omissions may be made to system 100. System 100 may each include more, fewer, or other components to carry out the various functions described herein. For example, activation server 115 and authorization server 120 may be combined into a single server configured to carry out the respective processes of each of activation server 115 and authorization server 120. In some embodiments, system 100 may further include an account manager system associated with the account for which the temporary authorization is provided. In this manner, the account manager system may serve as an intermediary between the account and merchant POS 125. In this manner, system 100 may be interoperable with a wide range of accounts regardless of the particular account management associated with the specific account. While described as particular components of system 100 carrying out various functions, different or additional components may carry out one or more of those functions, or parts of those functions.

FIG. 2 illustrates an example system 200 for registering a user for a rent-to-own arrangement. In certain embodiments, system 200 may be a portion of system 100. For example, system 200 may comprise user device 110, activation server 115, and database 130.

In certain embodiments, activation server 115 comprises interface 116, memory 117, and processing circuitry 118. Memory 117 may store instructions that, when executed by processing circuitry 118, may cause processing circuitry 118 of activation server 115 to perform any of the operations of activation server 115 described in the present disclosure. In certain embodiments, activation server 115 may enhance the establishment of RTO arrangements by registering users and generating a temporary authorization on an account concurrently, or as parallel processes or shortly subsequent to the other process.

Processing circuitry 118 is any electronic circuitry, including, but not limited to microprocessors, application specific integrated circuits (ASIC), application specific instruction set processor (ASIP), and/or state machines, that communicatively couples to memory 117 and controls the operation of activation server 115. Processing circuitry 118 may comprise one or more processors that are 8-bit, 16-bit, 32-bit, 64-bit or of any other suitable architecture. Processing circuitry 118 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processing circuitry 118 may include other hardware and software that operates to control and process information. Processing circuitry 118 executes software stored on memory to perform any of the functions described herein. Processing circuitry 118 controls the operation and administration of activation server 115 by processing information received from network 101, user device 110, and memory 117. Processing circuitry 118 may be a programmable logic device, a microcontroller, a microprocessor, any suitable processing device, or any suitable combination of the preceding. Processing circuitry 118 is not limited to a single processing device and may encompass multiple processing devices.

Memory 117 may store, either permanently or temporarily, data, operational software, or other information for processing circuitry 118. Memory 117 may include any one or a combination of volatile or non-volatile local or remote devices suitable for storing information. For example, memory 117 may include random access memory (RAM), read only memory (ROM), magnetic storage devices, optical storage devices, or any other suitable information storage device or a combination of these devices. The software represents any suitable set of instructions, logic, or code embodied in a computer-readable storage medium, including a non-transitory computer-readable medium. For example, the software may be embodied in memory 117, a disk, a CD, or a flash drive. In particular embodiments, the software may include an application executable by processing circuitry 118 to perform one or more of the functions described herein.

Interface 116 may be any suitable interface to transmit and/or receive information for registering and establishing a RTO arrangement with activation server 115. In certain embodiments, interface 116 includes one or more transceivers capable of communicating with network 101, user device 110, authorization server 120, database 130, and/or any external systems or networks. For example, interface 116 of activation server 115 may include a communication interface configured to communicate rent-to-own options and/or a temporary authorization to user device 110 of user 105 according to various embodiments disclosed herein. Activation server 115 may comprise any additional elements necessary to incorporate Activation server 115 into system 100 and perform the functions as described in particular embodiments herein.

In certain embodiments, user device 110 and activation server 115 may communicate back and forth to register user 105 and provide a temporary authorization on an account to purchase the RTO product. Certain embodiments in this disclosure may use a shed as an example RTO product, but any tangible item is contemplated in the various embodiments disclosed herein. FIG. 2 illustrates one example embodiment of activation server 115 communicating with user device 110. In some embodiments, user 105 may operate user device 110 to send a registration request 205 to activation server 115. For example, user 105 may input identification information, user preferences for the RTO product, location of the user and/or the installation location of the RTO product, and/or references into user device 110. In some cases, user device 110 may comprise an application configured to receive the inputted information by user 105 by one or more interfaces of user device. The application may send instructions to processing circuitry of user device 110 to manipulate the inputted information to generate a registration request, such as registration request 205. User device 110 may then send registration request 205 comprising that information to activation server 115.

In some embodiments, registration request 205 comprises certain fillable fields of information, in which user 105 may choose from pre-selected options, or alternatively, input a different option, to fill the fields. These fields may be compiled into a data structure, which is compatible with activation server 115. For example, the filled-in fields may be compiled into registration request 205, with a particular data structure that may be read and decoded by activation server 115. The compilation of the data structure may occur at user device 110 and/or at activation server 115. For example, an application on user device 110 may compile inputted information into the particular data structure to generate registration request 205. User device 110 may communicate registration request 205 to activation server 115, which may obtain the relevant information from registration request 205 according to the particular data structure.

In certain embodiments, registration request 205 may comprise a plurality of communications between user device 110 and activation server 115. For example, registration request 205 may comprise multiple communications comprising different information inputted by user 105 in response to requests by activation server 115. As a specific example, activation server 115 may request confirmation of inputted information or further information in response to a first communication as part of registration request 205. User device 110 may then communicate additional information in response to such requests. As another example, user 105 may alter one or more pieces of information embodied in registration request 205, such as particular RTO product characteristics. Accordingly, user device 110 may generate a subsequent communication to update registration request 205 at activation server, which may include the altered or additional information inputted by user 105.

In certain embodiments, activation server 115 may receive registration request 205 through interface 116 from user device 110. Activation server 115 may then determine user information 210 using information obtained from registration request 205. For example, activation server 115 may be configured to read into memory 117 information contained in registration request 205, including any inputted RTO product properties, user identifying information, RTO product installation location, or any other relevant information contained in registration request 205. Activation server 115 may also obtain additional user information using the information obtained from registration request 205. For example, activation server 115 may request additional information from user 105 via user device 110 based on information in registration request 205 or may, alternatively or additionally, use information in registration request 205 to request information from database 130 or external systems. For example, activation server 115 may use identifying information in registration request 205 to request a credit rating of user 105. As another example, activation server 115 may use the installation location to determine the address of the installation location and property ownership of the installation location and compare that information to user 105's identity. In this manner, activation server 115 may obtain user information 210, which may form a user profile for user 105 that may be applied at various stages of establishing the RTO arrangement.

In some embodiments, user information 210 may include one or more of a credit rating of user 105, an installation location of the RTO product, one or more user references, and a user preference for the RTO product. For example, user 105 may supply one or more user references that may be contacted to verify user 105's identity and credit worthiness. This information may be added to user information 210 to provide a complete picture of user 105's ability to enter into an RTO arrangement and make full payments for the RTO product. Additionally, third-party systems, such as social media platforms, may be searched for additional information about user 105. For example, using identifying information of user 105, activation server 115 may search social media platforms for information that may disqualify user 105 from the RTO arrangement. In one example, activation server 115 may obtain information of illegal activity by user 105 through their social media presence or that the provided information in registration request 205 is inconsistent. In this manner, additional information may be obtained by activation server 115 to obtain helpful information to add to user information 210.

In certain embodiments, activation server 115 may obtain further information to determine user information 210 by accessing external systems and/or data sources. For example, activation server 115 may access public databases and social media websites and systems to determine additional information about user 105. Using the identity of user 105 contained in registration request 205, activation server 115 may confirm the identity of user 105, thereby reducing the chance of fraudulent authorization. Additionally, activation server 115 may use a provided location in registration request 205 to validate that location for a RTO product. For example, activation server 115 may confirm that the provided address is a valid address, or alternatively request additional address information if it is not a valid address or there are multiple addresses corresponding to the provided information. Further, activation server 115 may communicate with databases, such as criminal background and credit databases, to determine whether user 105 may qualify for a certain RTO arrangement. For example, activation server 115 may use the obtained information, such as the identity of user 105, from registration request 205 to communicate with a third party to determine whether user 105 has a criminal background. Similarly, activation server 115 may use the obtained information to determine the credit history of user 105. Additionally, activation server 115 may determine one or more user references. These user references may be provided by user 105 in order to verify the eligibility of user 105 for the RTO arrangement, including, but not limited to, verifying user 105's ability to make payments and/or user 105's prior history. This additional information may be used not only to determine for which options user 105 may be eligible, but also prevent fraudulent authorizations and minimize the risk associated with the RTO arrangement.

In certain embodiments, activation server 115 may determine user information 210 comprising a user preference. The user preference in user information 210 may include one or more characteristics or categories communicated with registration request 205. For example, user 105 may desire entering into a RTO arrangement for an outdoor shed to be placed on his property. Using user device 110, user 105 may select from predetermined categories of sheds and communicate that preference in registration request 205 to activation server 115. In certain embodiments, user 105 may provide certain criteria, such as square footage or construction of the shed, and activation server 115 may determine a user preference based on the provided criteria in registration request 205. In this manner, activation server 115 may properly determine user information 210, and use that to determine the possible RTO arrangements appropriate for user 105.

In certain embodiments, activation server 115 may determine one or more rent-to-own characteristics based on user information 210. For example, the credit history of user 105 may limit the value of the possible RTO product available for the RTO arrangement. In another example, the user preferences may limit the types or characteristics of the RTO products that may be offered as a RTO arrangement option. As another example, the location of user 105 or the desired installation location of the RTO product may limit the size or type of RTO product available for the RTO arrangement. In this manner, activation server 115 may efficiently narrow the range of RTO arrangement options that may be presented to user 105, while at the same time presenting only options that user 105 may be qualified for and is likely to complete payment on without default or substantial risk.

In certain embodiments, the determined RTO characteristics based on user information 210 may be used by activation server 115 as a filter to eliminate incompatible RTO options. Using the shed example, each RTO option may have its own RTO characteristics, such as construction, square footage, volume, accessories, term length, minimum payments, etc. Activation server 115 may compare the determined characteristics to the RTO options and eliminate the RTO options that are incompatible. An RTO option may be incompatible if one or more of its characteristics do not match the determined RTO characteristics. In some embodiments, an RTO option may be eliminated if it does not match exactly with the determined RTO characteristics. In other embodiments, an RTO option may still be compatible if it does not exactly match the determine RTO characteristics. There may be ranges in which particular characteristics of the RTO characteristics would be compatible. For example, the square footage characteristics may be compatible if within 25 square feet of the determined RTO characteristic. In some embodiments, compatible RTO options may be those options that most closely match the determined RTO characteristics. For example, there may be cases where no single RTO option matches all or any of the determined RTO characteristics, but activation server 115 may find one or more RTO options compatible based on their characteristics being within a certain threshold difference to the determined RTO characteristic. Each characteristic may have different threshold differences or ranges in which compatibility may be found. In some embodiments, certain characteristics must match exactly for the RTO option to be compatible. For example, an RTO option that exceeds the determined RTO price maximum based on user information 210, even if the other characteristics are matching, that RTO option may be excluded as incompatible.

Based on the determined rent-to-own characteristics, activation server 115 may determine which RTO options user 105 are compatible with user information 210, including which options user 105 qualifies for and match the preferences. In certain embodiments, activation server 115 may communicate one or more rent-to-own options 215 to user device 110 through interface 116 based on the one or more determined rent-to-own arrangement characteristics. User 105 may then choose whether to accept one of the one or more RTO options. Alternatively, if no RTO options 215 are compatible with user information 210, activation server 115 may communicate a request to user device 110 to provide additional information or change one or more pieces of information to alter registration request 205. RTO options 215 may be displayed on a graphical user interface of user device 110. In some embodiments, user device 110 may communicate additional information to activation server 115, which may edit or add to user information 210. In such cases, activation server 115 may again determine one or more rent-to-own characteristics and communicate RTO options 215, which may include different and/or additional options.

If user 105 accepts a communicated RTO option in RTO options 215, user device 110 may communicate acceptance 220 to activation server 115 indicated the accepted RTO option. Activation server 115 may store the accepted RTO option and its criteria, including the RTO product characteristics. In certain embodiments, activation server 115 may use the accepted RTO option criteria to calculate a minimum purchase amount and a maximum purchase amount for the accepted RTO option. For example, if user 105 has accepted a RTO option for a shed with a particular construction and square footage, activation server 115 may calculate a minimum and a maximum purchase amount that would be required to acquire the shed matching the accepted RTO option. In some embodiments, the product of the accepted RTO option may be available from one or more merchants and activation server 115 may determine the minimum and maximum purchase amounts based on the available prices of the product. For example, activation server 115 may determine an estimated cost of the RTO product based on the retail prices from one or more merchants.

Based on the estimated cost of the RTO product, activation server 115 may calculate the minimum and maximum purchase amounts. In one example, activation server 115 may determine the minimum and maximum purchase amounts as a set percentage deviation from the determined estimated cost of the RTO product. In this example, the minimum purchase amount may be set to 90% (or less 10% the estimated cost) of the estimated cost and the maximum purchase amount be set to 110% of the estimated cost. The percentage difference from the estimated cost may be asymmetrical, such that the percentage deviation may be different between the minimum purchase amount and the maximum purchase amount, e.g., 80% of the estimated cost for the minimum purchase amount and 105% of the estimated cost for the maximum purchase amounts.

In some embodiments, the minimum and maximum purchase amounts may be a fixed amount, respectively, from the estimated cost of the RTO product. For example, the maximum purchase amount may be the estimated cost of the RTO product plus $50 and the minimum purchase amount may be the estimated cost less $50. As with the percentage example above, the amount of deviation from the estimated cost may be asymmetrical. In certain embodiments, the allowed deviation of the minimum and/or maximum purchase amounts may be based on the estimated cost of the RTO product. For example, there may be more absolute deviation allowed for a more costly RTO product, to allow for fluctuations in price and differences between retailers and taxes. In another example, there may be less percentage deviation allowed for a percentage calculated minimum and maximum purchase amounts, as the allowed deviation may grow as the estimate cost rises. In this manner, activation server 115 may calculate minimum and maximum purchase amounts based on the accepted RTO option.

In certain embodiments, activation server 115 may then generate a temporary authorization 225 to purchase the RTO product according to the accepted RTO option. Activation server 115 may construct a specific data structure to generate temporary authorization 225 based on the accepted RTO option and the calculated minimum and maximum purchase amounts. For example, activation server 115 may generate an array comprising select information regarding user 105, the accepted RTO option, and the calculated minimum and maximum purchase amounts. In a specific example, temporary authorization 225 may comprise an array including one or more of identifying information of user 105, an identifier of user device 110 that may use temporary authorization 225, the minimum purchase amount, the maximum purchase amount, information identifying the RTO product, including any qualifications such as a Merchant Category Code (MCC), Merchant ID, Universal Product Code (UPC), Stock Keeping Unit (SKU), an expiration time, the number of times authorization may be granted, an account from which funds may be withdrawn, a unique transaction code associated with temporary authorization 225, and/or pointers to memory 117 or to locations in database 130 comprising any of the above information. In this manner, temporary authorization 225 may comprise a data structure comprising all of the relevant parameters to ensure that temporary authorization 225 is only used to purchase the RTO product of the accepted RTO option. For example, identifying information of user 105 may be used to confirm at the time of purchase that user 105 is the actual user of temporary authorization 225. The identifier of user device 110 may ensure that only user device 110 may be used to communicate temporary authorization 225 to a merchant or retailer. The information regarding the RTO product and minimum and maximum purchase amounts ensure that only the specified RTO product is purchased. If another product is purchased, the RTO arrangement may fail, as the arrangement may be only for that specific product. Further, it may prevent user 105 from misappropriating any funds using temporary authorization 225.

Temporary authorization 225 may include an expiration time, which may indicate when temporary authorization 225 may expire and no longer be used by user device 110. This may ensure that temporary authorization 225 may be used by the customer in a specified time period and there are no lingering transactions that may occur unexpectedly on the account associated with temporary authorization 225. Temporary authorization 225 may also include account information. For example, temporary authorization 225 may include an encrypted account credential that may be used by a merchant to request funds from a specific account, such as a bank account or a credit account. In this manner, temporary authorization 225 may be generated so that funds are only withdrawn from a specific account. Further, temporary authorization 225 may include a unique transaction code specific to temporary authorization 225. For example, a unique code may be generated when generating temporary authorization 225. This unique code may be stored at activation server 115 and/or database 130 in addition to being communicated to user device 110 as part of temporary authorization 225. The unique code may be communicated to activation server 115 and/or authorization server 120 at the time of purchase to further authenticate the pending transaction to purchase the RTO product. The unique code may further secure the authorization on the target account and ensure that the number authorizations to purchase the RTO product do not exceed the allotted amount.

In certain embodiments, activation server 115 may communicate through the interfaces 116, to user device 110 and in response to an acceptance of one of RTO options 210, a temporary authorization 225 on an account to purchase a rent-to-own item according to the accepted rent-to-own option. For example, user device 110 may store temporary authorization 225 on user device 110 using a specific application loaded on user device 110. The application may enable user 105 to view on user device 110 the various criteria and limitations of temporary authorization 225. For example, one or more interfaces of user device 110 may display details regarding temporary authorization 225, such as identifying information regarding the RTO product, minimum and maximum purchase amounts, the expiration time for the authorization, one or more merchants at which the RTO product may be purchased, and/or any information contained within temporary authorization 225.

Temporary authorization 225 may allow user 105 using user device 110 to purchase the RTO item according to the accepted RTO option. For example, temporary authorization 225 may be associated with an account. In some cases, temporary authorization 225 may comprise one more account identifiers, such as a card number or a bank account number associated with the account. Temporary authorization 225 may be stored in user device 110. In some embodiments, temporary authorization 225 may be configured to be stored in a secured mobile wallet. Temporary authorization 225 may be encrypted or stored within an encrypted portion of memory of user device 110. In this manner, temporary authorization 225 may be generated concurrently with the selection of the RTO or immediately thereafter and may be accessed securely using user device 110, without waiting for a transfer of funds or a receiving a physical credential.

In certain embodiments, activation server 115 may store one or more of user information 210, rent-to-own options 215, the accepted RTO option, the calculated minimum and maximum purchase amounts, and the temporary authorization 225 at database 130. Activation server 115 may communicate this information to database 130 at any or at every stage between receiving the initial registration request 205 and after sending temporary authorization 225. Activation server 115 may store this information in database 130 so that this information may be accessed again by activation server 115 at a later time or may be accessed by other components of system 100, such as authorization server 120. In some embodiments, activation server 115 may in addition to or instead of communicating the information to database 130, also communicate one or more of these pieces of information directly to authorization server 120 or other components of system 100. In certain embodiments, activation server 115 may determine if user 105 is the owner of the property at the installation location prior to generating temporary authorization 225. For example, if user 105 indicates an address of an installation location of a RTO shed, activation server 115 may obtain information necessary to determine whether that location is owned by user 105, or whether it is owned by another. In some embodiments, activation server 115 may use location information to determine the address of the installation location. Using the address of the installation location, activation server 115 may access property records, such as property tax records, stored in a county records database or elsewhere. Activation server 115 may compare the identifying information of user 105 to the property tax records of that address to see if they match. If the information matches, activation server 115 may indicate that user 105 is the owner of the property at the desired installation location and store that indication in memory 117 and/or at database 130. If the records do not match, activation server 115 may communicate with user device 110 to request additional information. For example, if the name in the property records is similar but not exactly matching the name provided by user 105, activation server 115 may request additional identifying information to confirm that user 105 is the owner, such as a full legal name or a tax ID number to cross reference the property records.

If the installation location is owned by someone other than user 105, activation server 115 may attempt to confirm that user 105 has authorization to install the RTO product at that location. For example, activation server 115 may request additional information to prove user 105 is the owner or request information of the owner to confirm user 105's authorization to install the RTO product at that location. In some embodiments, if the owner is not user 105, activation server 115 may send the owner a confirmation request to authorize the rent-to-own option at the installation location. The confirmation request may include information regarding the RTO shed that may be installed on the property, the identity of user 105 requesting to install the RTO shed, and an authorization request. Once the owner authorizes the installation of the

RTO product, activation server 115 may continue to determine the RTO characteristics and provide RTO options 215 to user device 110, as described above. In some embodiments, the owner's authorization may be conditional, which activation server 115 may use in determining the RTO characteristics available to user 105. For example, the owner may only authorize a structure, such as a shed, if it is less than twelve feet tall. Activation server 115 may then only provide RTO options for sheds less than that height to user device 110.

In addition to the calculated minimum and maximum purchase amounts, the accepted RTO option may include additional parameters controlling scope of temporary authorization 225. In certain embodiments the accepted rent-to-own option comprises one or more of a MCC, Merchant ID, UPC, and SKU. Temporary authorization 225 may be limited to a merchant with a particular MCC or Merchant ID or even to specific products indicated by the UPC or SKU. For example, a RTO shed to be purchased according to an accepted RTO option may only be purchased at a particular retailer. If user device 110 uses temporary authorization 225 at a different retailer or attempts to purchase an item differing from the RTO option UPC or SKU, the transaction may be declined. In this manner, the lessor/seller may control the use of the account when purchasing products to prevent fraud and reduce overall risk.

In certain embodiments, activation server 115 may remove the temporary authorization 225 on the account after a predetermined period of time. In some embodiments, temporary authorization 225 may only be valid for a period of 24 hours or less. For example, temporary authorization 225 may include an expiration time and/or date. In some instances, activation server 115 may communicate with user device 110 at the end of the predetermined period of time to remove temporary authorization 225. In another example, activation server 115 may communicate the expiration time and/or date separate form temporary authorization 225 to user device 110 and authorization server 120. In this case, user 105 may know of the expiration of temporary authorization 225 and if temporary authorization 225 is not used within the predetermined period of time, authorization server 120 may prevent the withdrawal of funds from the account. By limiting the period of use of temporary authorization 225, activation server 115 may prevent abuses and unexpected uses of the account.

In certain embodiments, even after expiration, activation server 115 may renew temporary authorization 225. For example, user 105 may still qualify and desire to complete the RTO arrangement. In certain embodiments, activation server 115 may receive a renewal request from user device 110. Activation server 115 may then determine changes, if any, to user information 210 using information obtained from the renewal request. For example, user 105 may have updated one or more of the installation location, references, preferences, or other information that may alter or affirm the RTO options available to user 105.

In certain embodiments, activation server 115 may reauthorize temporary authorization 225 on the account to purchase the rent-to-own item when the determined changes to user information 210 do not require the change of any of the rent-to-own characteristics of the accepted rent-to-own option. For example, if no changes to user information 210 are determined, the same accepted RTO option may be available to user 105. Similarly, if only incidental changes are determined, the same accepted RTO option can be reauthorized. In cases where there are substantial changes to user information 210, the accepted RTO option may no longer be available. For example, if there is a substantial change in user 105's credit or if the location is changed, the range of RTO characteristics may be changed sufficiently to no longer allow the previously accepted RTO option. In this case, activation server 115 may indicate the new RTO options 215 in a new communication from which user 105 may choose.

Modifications, additions or omissions may be made to system 200. System 200 may each include more, fewer, or other components to carry out the various functions described herein. While described as particular components of system 200 carrying out various functions, different or additional components may carry out one or more of those functions, or parts of those functions.

FIG. 3 illustrates an example system 300 for authorizing user 105 to complete the establishment of a rent-to-own arrangement. In certain embodiments, system 300 may be a portion of system 100 in FIG. 1. For example, system 300 may comprise user device 110, merchant POS 125, authorization server 120, and database 130. In certain embodiments, authorization server 120 comprises one or more interfaces 121, memory 122, and processing circuitry 123.

Once temporary authorization 225 has been communicated to user device 110, user 105 may use user device 110 to purchase or acquire the RTO item of the accepted RTO option. For example, user device 110 communicates information contained within temporary authorization 225 to merchant POS 125. The information communicated to merchant POS 125 may identify an account from which funds may be withdrawn to purchase the item from the merchant. The information may further include any credentials associated with the account, such as PIN information or other security information, such as a unique transaction code associated with the RTO arrangement.

After receiving the information from user device 110, in certain embodiments, merchant POS 125, or any suitable point-of-sale portal, including an online portal or payment processing system, may, in response, communicate an authorization request 305. Merchant POS 125 may communicate authorization request 305 to a system managing the identified account. For example, the identified account may be associated with a particular account manager system. The account manager system may receive authorization request 305 and forward the transaction information contained within authorization request 305 to authorization server 120 through interface 121. In other embodiments, merchant POS 125 may communicate authorization request 305 to authorization server 120 directly. Authorization server 120 may confirm temporary authorization 225, thereby allowing the merchant POS to process the transaction for the RTO item and obtain payment from the account associated with temporary authorization 225.

In certain embodiments, after receiving authorization request 305, authorization server 120 may compare the accepted RTO option to authorization request 305. In some embodiments, authorization server 120 may access stored information in database 130 to make the comparison. For example, database 130 may comprise in memory or other storage information such as the minimum and maximum purchase amounts, the accepted RTO option and user information 210. In some embodiments, this information may be stored in memory 122 of authorization server 120, whereby authorization server 120 may access memory 122 when processing authorization request 305. In some embodiments, authorizing server 120 may compare authorization request 305 to temporary authorization 225. For example, it may compare particular array elements of temporary authorization 225 to information contained within authorization request 305. Authorization server 120 may be configured to process authorization request 305 to identify relevant information contained therein, including the transaction amount, information identifying the purchased item, information identifying user device 110 and/or user 105, and/or a transaction code associated with temporary authorization 225. Authorization server 120 may then compare the constituent elements of temporary authorization 225 with the elements obtained from authorization request 305 to determine whether authorization should be confirmed. By comparing authorization request 305 and the accepted RTO option, authorization server 120 may ensure that the correct RTO item is purchased for the authorized amount.

In certain embodiments, authorization server 120 compares authorization request 305 by comparing the transaction purchase amount to the calculated minimum and maximum purchase amounts. For example, authorization request 305 may determine whether the transaction purchase amount is more than the minimum purchase amount and less than the maximum purchase amount. As a specific example, if authorization server 120 receives a request to authorize a transaction for $1,200 for an outdoor shed, authorization server 120 may compare the $1,200 amount to the minimum and maximum amounts calculated. For this example, if the estimated cost of the shed was $1,160, activation server 115 may calculate, based on a 10% allowed deviation, a minimum purchase amount of $1,044 and a maximum purchase amount of $1,276. In this example, since the $1,200 transaction purchase amount is between the minimum and maximum purchase amounts calculated for the RTO shed, authorization server 120 may determine that the authorization request 305 is a valid authorization request based on temporary authorization 225. In this manner, authorization server 120 may use the comparison to the minimum and maximum amounts, to determine whether to confirm authorization to purchase the rent-to-own item.

In particular embodiments, authorization server 120 may determine that the transaction purchase amount indicated by authorization request 305 exceeds the maximum purchase amount for temporary authorization 225. In this case, authorization server 120 may communicate to user device 110 that the purchase amount exceeds the accepted RTO option. In some embodiments, authorization server 120 may concurrently communicate to merchant POS 125, directly or indirectly through an account manager system, the denial of authorization request 305. In some embodiments, user device 110 may communicate additional information requesting the modification of the accepted RTO option. Based on a determination by activation server 115 and/or authorization server 120 using user information 210 and/or additional information from user device 110, the maximum purchase amount may be recalculated to a higher amount. In this case, a new temporary authorization may be generated and communicated to user device 110. User device 110 may subsequently transmit the new temporary authorization to merchant POS 125, thereby generating a new authorization request to authorization server 120. If the purchase amount is below the newly calculated maximum purchase amount, authorization server 120 may then authorize the purchase.

In particular embodiments, authorization server 120 may determine that the purchase amount is below the minimum purchase amount calculated. In some embodiments, authorization server 120 may not authorize the transaction and communicate to merchant POS 125 and/or user device 110 a denial of authorization for authorization request 305. In other embodiments, authorization server 120 may authorize the transaction even though the purchase amount is below the minimum purchase amount calculated for the RTO option. For example, if the information in authorization request 305 otherwise matches the information in temporary authorization 225, authorization server 120 may authorize the purchase of the RTO product. This may occur in several situations. In one example, the particular RTO product may be on sale, thereby reducing its price below an expected deviation calculated by activation server 115. Alternatively, user 105 may have selected a different RTO product that is otherwise compatible with the RTO characteristics of the accepted RTO option. In this case, a specific product may not have been specified by temporary authorization 225 or substitute products may be allowed for particular RTO products based on user 105's discretion. In such instances, authorization server 120 may also recalculate the RTO option. For example, the lower purchase amount may change one or more RTO characteristics. In particular, the lower purchase amount may change the number of payments, the amount of each payment, the purchase price at the end of lease term, an interest rate, etc. In this manner, authorization server 120 may flexibly determine whether to authorize the transaction even if it does not exactly correspond to the parameters in temporary authorization 225.

In particular embodiments, authorization server 120 determines that the purchase amount is below the maximum purchase amount and above the minimum purchase amount calculated. In this case, authorization server 120 may authorize the transaction to purchase the RTO item and debiting the particular account for payment. In response, authorization server 120 may communicate an authorization confirmation 310 to merchant POS 125. In certain embodiments, authorization server 120 may communicate authorization confirmation 310 to an account manager system of the account associated with temporary authorization 225 instead of merchant POS 125 directly. In this manner, account manager system may receive the authorization confirmation and ready the account to complete the transaction. The account manager system may forward authorization confirmation 310 to merchant POS 125 or otherwise communicate confirmation of the authorization to merchant POS 125. Merchant POS 125 may use authorization confirmation 310 to complete the transaction. In some embodiments, authorization server 120 may also communicate the RTO arrangement agreement to user device 110, or to user 105 by any other suitable means, to complete the RTO arrangement with the purchase of the RTO product.

Authorization server 120 may also use other or additional criteria to determine whether to authorize the purchase on the account. For example, temporary authorization 125 may be subject to restrictions other than a minimum and maximum purchase amount. In certain embodiments, authorization server 120 may compare the authorization request 305 to an MCC, a Merchant ID, a UPC, and/or a SKU that is associated with the accepted RTO option. For example, authorization request 305 may include a merchant code indicating the retailer of the merchant POS 125. If the merchant code does not match one of the merchants authorized for the particular RTO option, the transaction may be denied by authorization server 120. Similarly, if the product indicated in authorization request 305 differs from the SKU or UPC of the RTO item indicated in the accepted RTO option, authorization server 120 may also deny authorization on the account. In this manner, authorization server 120 may make additional comparisons between authorization request 305 and the accepted RTO option and calculated parameters to ensure the correct RTO item is purchased subject to the RTO arrangement.

In particular embodiments, the account authorized for temporary authorization 225 has a balance of zero or has only a nominal balance prior to authorization confirmation by authorization server 120. For example, the account may only have a balance after authorization server 120 provides confirmation to a third-party account manager system controlling the associated account. In response to the confirmation, the third-party account manager system may transfer an amount equal to, or approximately equal to, the purchase amount in the authorization request 305. In some embodiments, authorization server 120 may communicate the amount to transfer to the account in the confirmation to the account manager system. For example, authorization server 120 may communicate an amount based on the minimum and maximum purchase amounts and/or the amount contained in the authorization request 305 forwarded by the account manager system. In this manner, even if there is unauthorized access to the account, no funds may be accessed without confirmation by authorization server 120.

Authorization server 120 may be configured to ensure that the third-party account manager system receives the authorization confirmation within a set period of time required by the account management system. For example, certain account manager systems implementing just-in-time funding may require confirmation within a few milliseconds; otherwise, the transaction may be denied and no funds are transferred into the account, even if confirmation is later sent by authorization server 120. In certain embodiments, authorization server 120 may be configured to authorize the account within 2-10 milliseconds after receiving the authorization request on the account. For example, the account manager system may require a response within 4 milliseconds before determining whether the transaction may occur. In this manner, authorization server 120 may ensure that the necessary funding is provided to the account to cover the transaction purchase amount to complete the purchase of the RTO item.

In certain embodiments, authorization server 120 may remove temporary authorization 225 on the account after authorizing the account to purchase the rent-to-own item. For example, authorization server 120 may communicate to user device 110 to remove temporary authorization 225. For example, authorization server 120 may communicate a new authorization overriding temporary authorization 225 or changing one or more values within temporary authorization 225. In other embodiments, temporary authorization 225 may update one or more values contained within temporary authorization 225 automatically in response its use to purchase the target RTO item. For example, an application on user device 110 may, in response to confirming the use of temporary authorization 225, alter a stored use number value in the data structure to reflect the use of the authorization. In some embodiments, authorization server 120 may alter one or more values associated with temporary authorization 225 in memory 122 and/or in database 130 to prevent a further authorization on the account. For example, if temporary authorization 225 is unaltered on user device 110 after a successful transaction, inadvertently or purposefully, subsequent authorization attempts using temporary authorization 225 may be prevented by authorization server 120 when comparing authorization request 305 to the information stored related to the associated temporary authorization 225 accessible to authorization server 120. In this manner, the account is further protected from additional transactions that are not authorized or subject to the RTO arrangement.

In certain embodiments, authorization server 120 may receive confirmation of the purchase of the rent-to-own item and the accepted rent-to-own option. For example, user device 110 may communicate a complete status after the purchase. In another example, authorization server 120 may receive confirmation from the third-party account manager system that there has been successful funding of the account and confirmation sent to merchant POS 125. In this manner, authorization server 120 may ensure that the transaction is complete and proceed with finalizing the RTO arrangement.

Based on the confirmation of the purchase of the rent-to-own item and the accepted rent-to-own option, authorization server 120 may associate user 105 of user device 110 with a rent-to-own contract for the purchased rent-to-own item. In certain embodiments, authorization server 120 may obtain the accepted RTO option from memory 122 and/or database 130. The accepted RTO option may include information such as a term length, a payment schedule, a payment plan, a payment frequency, and other characteristics of the RTO option. Authorization server 120 may then associate user 105 with these terms and conditions and finalize an RTO arrangement into a RTO contract for the purchased RTO item. Authorization server 120 may communicate the RTO contract to user 105 for final authorization. In some embodiments, the confirmation of the transaction provides the final authorization for the RTO contract. In other embodiments, temporary authorization 225 may not be communicated prior to the final authorization for the RTO contract.

Modifications, additions or omissions may be made to system 300. System 300 may each include more, fewer, or other components to carry out the various functions described herein. While described as particular components of system 300 carrying out various functions, different or additional components may carry out one or more of those functions, or parts of those functions.

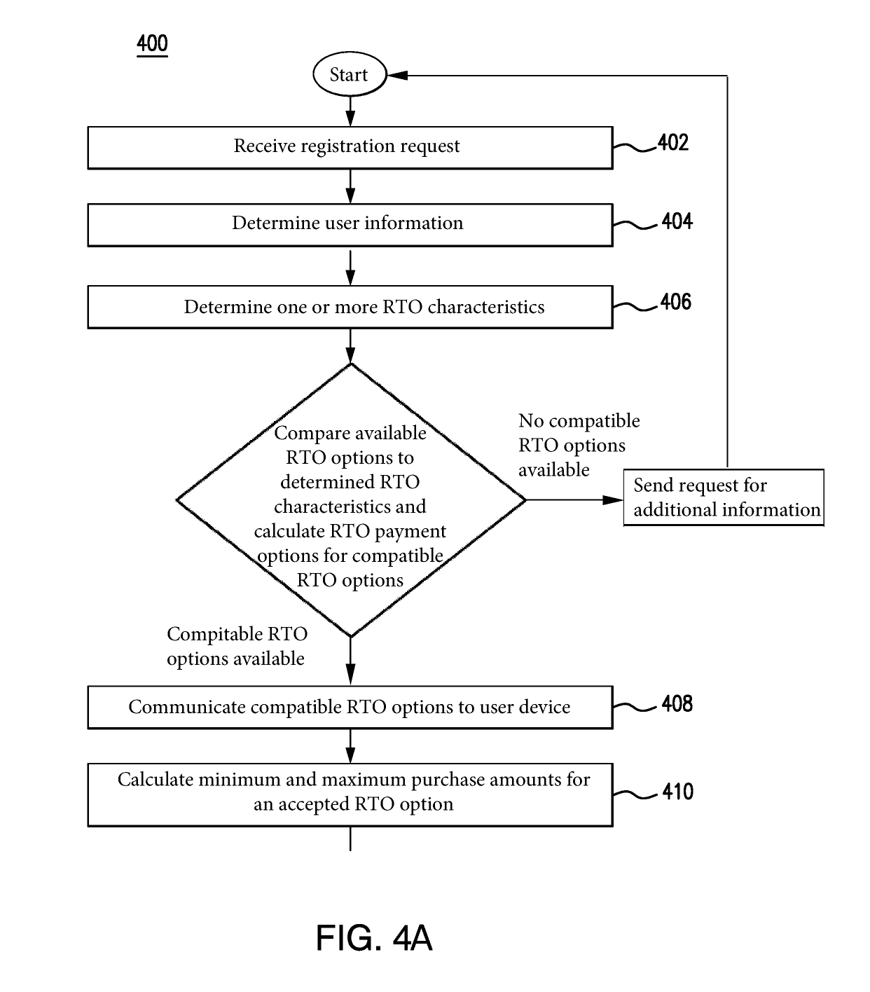

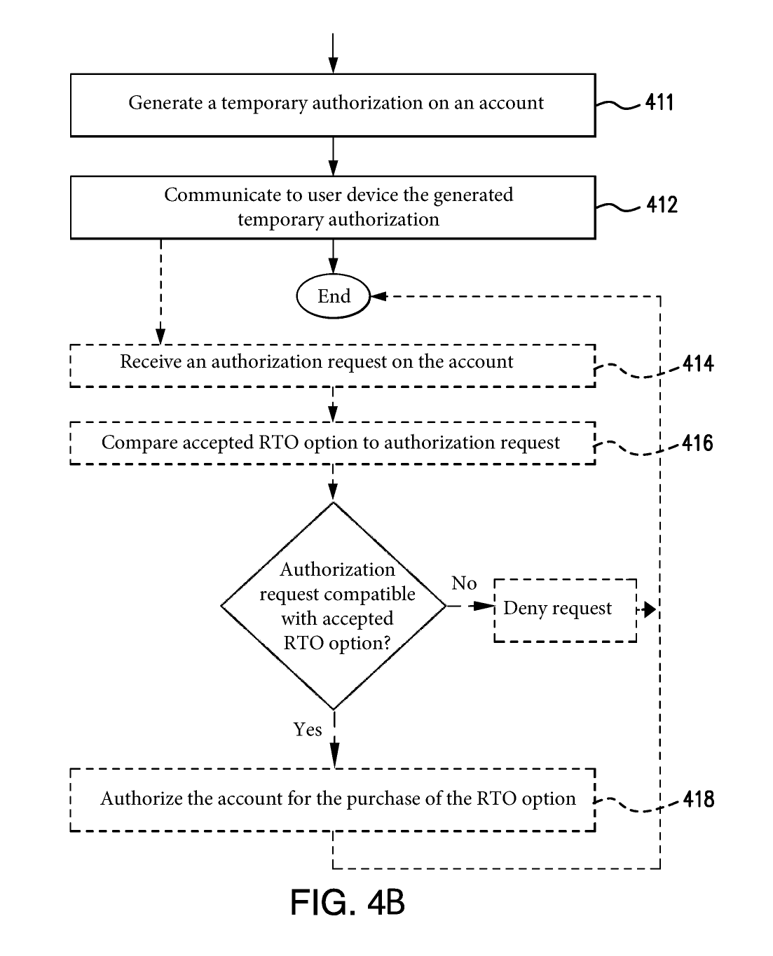

FIGS. 4A and 4B are a flowchart illustrating a method 400 for establishing a rent-to-own arrangement using system 100 of FIG. 1. In particular embodiments, one or more components of system 100 performs method 400. In some embodiments, one or more of activation server 115 and authorization server 120 perform one or more steps of method 400. By performing method 400, system 100 establishes a RTO arrangement with a reduction of unnecessary processing resources and a reduced risk of fraud and lower transaction costs.

Method 400 may begin with step 402, as shown in FIG. 4A. At step 402, activation server 115 may receive registration request 205 from user device 110 of user 105. For example, both user device 110 and activation server 115 may be connected via network 101 or another communication system. In some embodiments, user device 110 may communicate to activation server 115 through the use of an application on user device 110. For example, if user device 110 is a smart phone, an application installed on user device 110 may allow user 105 to input information and generate registration request 205.

At step 404, activation server 115 may determine user information 210 using information obtained from registration request 205. For example, activation server 115 may extract user information 210 directly from registration request 205 or additionally, or alternatively, access other sources of information to determine user information 210 based on information in registration request 205. In certain embodiments, user information may include one or more of a credit rating of user 105, an installation location, one or more user references, and a user preference. In some embodiments, activation server 115 may access external systems to determine user information 210.

At step 406, activation server 115 may determine one or more rent-to-own arrangement characteristics based on user information 210. For example, activation server 115 may determine one or more user preferences with which available RTO products are filtered to determine compatibility. In some instances, no compatible RTO options are available based on user information 210. In that case, activation server 115 may send a request for additional information to user device 110. For example, activation server 115 may request different user preferences or suggest alternatives to provided information that may broaden the compatible RTO options. If one or more compatible RTO options are available, activation server 115 may communicate to user device 110 one or more RTO options based on the characteristics in step 408. The RTO options communicated may include the RTO characteristics and payment options associated with the particular RTO option.

User 105, using user device 110, may receive the one or more RTO options and accept one of the options. Activation server 115 may receive the acceptance of the particular RTO option from user device 110. At step 410, activation server 115 may calculate a minimum purchase amount and a maximum purchase amount for an accepted RTO option. The calculation of the minimum and maximum amounts may be based on the RTO characteristics associated with the accepted RTO option. For example, the minimum and maximum amounts may indicate a range of purchase prices for the RTO item in the accepted RTO option. The purchase price may be based on various factors, such as the location of user 105, an indicated retailer or merchant, and the time of purchase. The calculation of the minimum and maximum purchase amounts may be calculated based on a percentage deviation allowed from an estimated cost of the RTO product and/or an absolute deviation from the estimated cost.

Using the calculated minimum and maximum purchase amounts for the accepted RTO option, activation server 115 may generate a temporary authorization on an account to purchase the RTO product in step 411. Generating the temporary authorization 225 may comprise constructing a data structure incorporating the relevant details of the accepted RTO option. For example, activation server 115 may associate array elements of the temporary authorization 225 with user 105's identifying information, minimum and maximum purchase amounts, RTO product details, an expiration time, a unique transaction code, and/or pointers to any of the above to memory or storage locations at activation server 115 and/or database 130.

Method 400 may continue from step 410 in FIG. 4B. At step 412, activation server 115 may communicate to user device 110, in response to the acceptance of one of the RTO options, temporary authorization 225 on an account to purchase a RTO item according to the accepted RTO option. For example, activation server 115 may communicate a temporary account number to a mobile wallet on user device 110. In this manner, user 105 may obtain temporary authorization 225 through user device 110, which may be used to purchase the RTO item using temporary authorization 225.

In particular embodiments, method 400 may comprise additional steps. For example, in certain embodiments, method 400 may include additional optional steps after step 412, as shown in the dashed boxes in FIG. 4B. In certain embodiments, method 400 may proceed to step 414 instead of ending at step 412. At step 414, authorization server 120 may receive an authorization request on the account from a merchant. The authorization request may include information, such as the purchase price, the merchant, the item description or indication such as a SKU or UPC.

At step 416, authorization server 120 may then compare the accepted RTO option to the authorization request. Authorization server 120 may compare temporary authorization 225 with the authorization request to confirm that the correct RTO product is being purchased in accordance with the accepted RTO option. As described in detail previously, authorization server 120 may determine whether the authorization request is compatible with the accepted RTO option. If the request is not compatible, authorization server 120 may communicate a denial of the request. Authorization server 120 may only authorize the account when the purchase amount of the received authorization request is between the minimum purchase amount and the maximum purchase amount, inclusive. In some embodiments, authorization server 120 may only authorize the account if the received authorization matches the MCC, Merchant ID, SKU, and/or UPC of the accepted RTO option. If the authorization request is compatible, then authorization server 120 may proceed to authorize the use of the associated account. In this manner, authorization server 120 may prevent unintended authorization on the account.

At step 418, authorization server 120 may authorize the account to purchase the RTO item. In certain embodiments, authorizing the account occurs within 5 milliseconds after receiving the authorization request on the account. In this manner, authorization server 120 may ensure the transaction occurs if it matches the accepted RTO option. Method 400 may end at step 418.

Modifications, additions or omissions may be made to method 400 depicted in FIGS. 4A and 4B. Method 400 may include more, fewer, or other steps. For example, steps may be performed in parallel or any suitable order. While discussed as activation server 115 and authorization server 120 performing the steps, any suitable component of systems 100, 200, and/or 300, may perform one or more of the steps of the method.

Certain embodiments provide one or more technical advantages. For example, certain embodiments may reduce the amount of computing resources in arranging the acquisition and financing of an RTO product. In one aspect, a system may combine systems for determining the RTO product to be acquired and financing for said RTO product, such that the determination of the RTO product to be acquired is carried out in parallel to the process of financing the purchase of the RTO product. As another example, certain embodiments may combine the two, previously incompatible systems for acquiring the RTO product and financing the RTO product, into a single system that reduces the use of processing resources. A system combining these systems may reduce any overlapping processing steps by enabling these two different systems to communicate through their respective interfaces, thereby reducing processing resources used. As yet another example, certain embodiments may create a new authorization state for use in a RTO arrangement, such that the acquisition and financing of the RTO product are tied together. This may result in several advantages, such as reducing the risk of fraud or non-payment by preventing the establishment of a certain RTO. Additionally, certain embodiments may authorize the account within five milliseconds after receiving the authorization request on the account and after confirmation of the purchase, establish the RTO contract. In this manner, the account may be funded only when the transaction is occurring, limiting the chance of fraudulent activity on the account and subsequently, or simultaneously, completing the RTO contract, thereby reducing the use unnecessary processing resources in providing RTO arrangements.

Certain embodiments may include none, some, or all of the above technical advantages. One or more other technical advantages may be readily apparent to one skilled in the art from the figures, descriptions, and claims included herein.

Although the present disclosure includes several embodiments, a myriad of changes, variations, alterations, transformations and modifications may be suggested to one skilled in the art and it is intended that the present disclosure encompass such changes, variations, alterations, transformations and modifications as fall within the scope of the appended claims.

What is claimed is:

1. A system, comprising:
a user device of a user configured to communicate a registration request;
an activation server communicatively coupled through a network to the user device, the activation server comprising:
memory configured to store one or more instructions;
one or more interfaces configured to receive the registration request from the user device; and
processing circuitry which, when one or more stored instructions are executed, is configured to:
determine user information based on information in the registration request, the user information comprising one or more of a credit rating of the user, an installation location, one or more user references, and a user preference; and
determine one or more rent-to-own arrangement characteristics based on the user information;
wherein the one or more interfaces are further configured to:
communicate to the user device one or more rent-to-own options based on the one or more determined rent-to-own arrangement characteristics; and
receive a selected rent-to-own option;
wherein the processing circuitry is further configured to calculate a minimum purchase amount and a maximum purchase amount for the selected rent-to-own option; and
wherein the one or more interfaces are further configured to communicate to the user device, in response to receiving the selected rent-to-own option, a temporary authorization on an account to purchase a rent-to-own item according to the selected rent-to-own option.

2. The system of claim 1, further comprising an authorization server, the authorization server comprising:
memory configured to store one or more instructions;
one or more interfaces configured to receive an authorization request on the account from a merchant system; and
processing circuitry which, when one or more stored instructions are executed, is configured to:
compare the selected rent-to-own option to the authorization request from the merchant system; and
authorize the account to purchase the rent-to-own item when a purchase amount of the received authorization request is between the minimum purchase amount and the maximum purchase amount, inclusive.

3. The system of claim 2, wherein the processing circuitry is configured to authorize the account within five milliseconds after receiving the authorization request on the account.

4. The system of claim 1, wherein the selected rent-to-own option comprises one or more of a Merchant Category Code (MCC), Merchant ID, Universal Product Code (UPC), and Stock Keeping Unit (SKU).

5. The system of claim 1, wherein the processing circuitry is further configured to remove the temporary authorization on the account after a predetermined period of time.

6. The system of claim 1, wherein:
the one or more interfaces are configured to receive a renewal request from the user device of the user; and
the processing circuitry is further configured to:
determine, in response to the renewal request, changes to user information based on the renewal request; and
reauthorize the temporary authorization on the account to purchase the rent-to-own item when the determined changes to the user information do not change of the rent-to-own characteristics of the selected rent-to-own option.

7. A method, comprising:
receiving a registration request from a user device;
determining user information based on information in the registration request, the user information comprising one or more of a credit rating of the user, an installation location, one or more user references, and a user preference;
determining one or more rent-to-own arrangement characteristics based on the user information;
communicating, to the user device, one or more rent-to-own options based on the one or more determined rent-to-own arrangement characteristics;
receiving a selected rent-to-own option;
calculating a minimum purchase amount and a maximum purchase amount for the selected rent-to-own option; and
communicating to the user device, in response to receiving the selected rent-to-own option, a temporary authorization on an account to purchase a rent-to-own item according to the selected rent-to-own option.

8. The method of claim 7, further comprising:
receiving an authorization request on the account from a merchant;
comparing the selected rent-to-own option to the authorization request from the merchant; and
authorizing the account to purchase the rent-to-own item when a purchase amount of the received authorization request is between the minimum purchase amount and the maximum purchase amount, inclusive.

9. The method of claim 8, wherein authorizing the account occurs within five milliseconds after receiving the authorization request on the account.

10. The method of claim 8, further comprising:
removing the temporary authorization on the account after authorizing the account to purchase the rent-to-own item;
receiving confirmation of the purchase of the rent-to-own item and the selected rent-to-own option; and
based on the confirmation of the purchase of the rent-to-own item and the selected rent-to-own option, associating the user of the user device with a rent-to-own contract for the purchased rent-to-own item.

11. The method of claim 7, wherein the selected rent-to-own option comprises one or more of a Merchant Category Code (MCC), Merchant ID, Universal Product Code (UPC), and Stock Keeping Unit (SKU).

12. The method of claim 7, further comprising removing the temporary authorization on the account after a predetermined period of time.

13. The method of claim 7, further comprising:
receiving a renewal request from the user device of the user;
determining, in response to the renewal request, changes to user information based on the renewal request; and
reauthorizing the temporary authorization on the account to purchase the rent-to-own item when the determined changes to the user information do not change the rent-to-own characteristics of the selected rent-to-own option.

14. The method of claim 7, wherein the temporary authorization on the account is communicated to a mobile wallet on the user device of the user.

15. A non-transitory computer readable medium comprising logic, the logic operable, when executed by processing circuitry, to:
receive a registration request from a user device;
determine user information based on information in the registration request, the user information comprising one or more of a credit rating of the user, an installation location, one or more user references, and a user preference;
determine one or more rent-to-own arrangement characteristics based on the user information;
communicate to the user device one or more rent-to-own options based on the one or more determined rent-to-own arrangement characteristics;
receive a selected rent-to-own option;
calculate a minimum purchase amount and a maximum purchase amount for the selected rent-to-own option; and
communicate to the user device, in response to receiving the selected rent-to-own option, a temporary authorization on an account to purchase a rent-to-own item according to the selected rent-to-own option.

16. The non-transitory medium of claim 15, wherein the logic is further operable, when executed by processing circuitry, to:
receive an authorization request on the account from a merchant system;
compare the selected rent-to-own option to the authorization request from the merchant system; and
authorize the account to purchase the rent-to-own item when a purchase amount of the received authorization request is between the minimum purchase amount and the maximum purchase amount, inclusive.

17. The non-transitory medium of claim 16, wherein the logic is further operable to authorize the account within five milliseconds after receiving the authorization request on the account.

18. The non-transitory medium of claim 15, wherein the selected rent-to-own option comprises one or more of a Merchant category code (MCC), Merchant ID, Universal Product Code (UPC), and Stock Keeping Unit (SKU).

19. The non-transitory medium of claim 15, wherein the logic is further operable, when executed by processing circuitry, to remove the temporary authorization on the account after a predetermined period of time.

20. The non-transitory medium of claim 15, wherein the logic is further operable, when executed by processing circuitry, to:
receive a renewal request from the user device of the user;
determine, in response to the renewal request, changes to user information based on the renewal request; and
reauthorize the temporary authorization on the account to purchase the rent-to-own item when the determined changes to the user information do not change the rent-to-own characteristics of the selected rent-to-own option.
